(19) United States
(12) Patent Application Publication
(10) Pub. No.: US 2007/0013648 A1
(43) Pub. Date: Jan. 18, 2007

(54) Display element, method of producing display element, and electronic apparatus including display element

(75) Inventors: Masahiko Yamaguchi, Fukushima-ken (JP); Takuo Sugiura, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/485,856

(22) Filed: Jul. 13, 2006

(30) Foreign Application Priority Data
Jul. 14, 2005 (JP) 2005-205409

(51) Int. Cl. G09G 3/36

(52) U.S. Cl. 345/102

(57) ABSTRACT

A display element that includes a liquid crystal display panel and a backlight that illuminates the liquid crystal display panel, a method of producing a display element, and an electronic apparatus including a display element are provided. The angle of the light emitted from the liquid crystal display panel can be set to match the viewing angle of the user viewing the display element.

This application claims the benefit of the Japanese Patent Application No. 2005-205409 filed Jul. 14, 2005, which is hereby incorporated by reference.

### BACKGROUND

1. Field

A display element that includes a liquid crystal display panel and a backlight that illuminates the liquid crystal display panel, a method of producing a display element, and an electronic apparatus including a display element are provided.

2. Related Art

Conventionally, in the technical field of liquid crystal display elements, there has been a strong demand to reduce electric power consumption and improve brightness by increasing the pixel area as much as possible. In order to satisfy these demands, a liquid crystal display element produced by applying a thick insulating film on the entire surface of an active matrix substrate and providing reflective pixel electrodes on the insulating film has been put to practical use. In a display element having such a structure in which pixel electrodes are disposed on an insulating film, electric short-circuiting between scanning lines and signal lines disposed on the insulating film at the lower layer and the pixel electrodes at the upper layer can be prevented. Therefore, the pixel electrodes can be provided over a large area in a manner such that the pixel electrode overlaps with the lines. Accordingly, most of the area where switching elements of thin film transistors (TFTs), scanning lines, and signal lines are provided can be used as pixel areas contribute to the display. The aperture ratio can be increased to obtain a bright display.

A liquid crystal display only including reflective pixel electrodes cannot be used in dark places. Therefore, a semi-transmissive liquid crystal display element that is provided with a backlight and that is partially capable of transmissive display is widely used.

In a semi-transmissive liquid crystal display element, one pixel is divided into a light-transmitting display unit and a reflective display unit. For example, to increase the area of the light-reflecting display units, the area of the light-reflecting display units has to be decreased. There is a trade-off between the transmissive display and the reflective display. Thus, if the area of the light-transmitting display units is small, brightness of the liquid crystal display element may be uneven.

To prevent the brightness from being uneven when the semi-transmissive liquid crystal display element is used for transmissive display by using the backlight, a liquid crystal display element including a microlens array interposed between a semi-transmissive TFT liquid crystal display panel and a backlight and a prism sheet disposed on the upper surface of the backlight has been proposed (for example, refer to Japanese Unexamined Patent Application Publication No. 2003-107505).

The liquid crystal display element according to Japanese Unexamined Patent Application Publication No. 2003-107505 is structured to emit a strongly directional beam of light to the light-transmitting display units by the microlens array interposed between the liquid crystal display panel and the backlight.

However, according to the structure of this liquid crystal display element, focusing is carried out by linking only the positions of one lens among the plurality of lenses included in the microlens array and one light-transmitting display unit of the liquid crystal display panel. Therefore, the light emitted from the backlight and focused by the microlens array is diffused in a narrow angle. Consequently, high brightness and excellent visibility are achieved in the direction of the normal line to the display surface of the liquid crystal display panel, but high brightness is only achieved is a narrow view angle.

The view angle can be widened by providing a diffusion plate on the display surface of the liquid crystal display panel. However, by doing so, diffusion of outside light is increased, causing a reduction in contrast. Moreover, brightness in the viewing direction of the user is decreased because the emitted light is diffused to the outside of the viewing angle of the user. Thus, the effect of focusing the light emitted from the backlight by the microlens array is reduced.

A mobile apparatus, such as a mobile phone, including a liquid crystal display element is often viewed while the user holds the apparatus in hand. Therefore, the viewing angle of the user is limited mainly to the lower half of the normal line to the display surface of the liquid crystal display panel. Thus, even if the brightness of the liquid crystal display element is high within an angular range near the normal line to the display surface, good visibility of the liquid crystal display element viewed by the user cannot be achieved.

For a direct-vision liquid crystal display element used for a mobile apparatus, a polarizing plate is often bonded to the liquid crystal display panel. Since the adhesive used for bonding the polarizing plate to the substrate causes refraction of light, the visibility of the liquid crystal display panel viewed by the user could be reduced even more.

A semi-transmissive liquid crystal display element or a transmissive liquid crystal display element according to an embodiment of the present invention has taken into consideration the above-identified problems, so that light emitted from the backlight is transmitted through the liquid crystal display panel at an optimal angle. In this way, a display apparatus having improved brightness and visibility and reduced electric consumption is provided.

### SUMMARY

A display element includes a liquid crystal display panel having liquid crystal sealed between first and second substrates. The first and second substrates are disposed opposite to each other. A backlight illuminates the liquid crystal display panel. Electrodes and an alignment film are provided on the liquid crystal layer side of the first substrate and the liquid crystal layer side of the second substrate. Some of the electrodes on the second substrate are light-reflecting pixel electrodes. A light-transiting portion is formed on part of each of the pixel electrodes.

Light-transmitting display units are formed by providing transparent electrodes in the areas where the light-transiting portions are formed. Areas where light-reflecting pixel electrodes are provided function as light-reflecting display units. The backlight is disposed on the second substrate side. Light emitted from the backlight and transmitted through the liquid crystal display panel is emitted from the liquid crystal display panel at a predetermined angle with directionality with respect to the normal line to the light-reflecting display unit or with respect to the display surface of the liquid crystal display panel.

According to the above-described structure, the angle of the light emitted from the liquid crystal display panel can be set to have directionality. Thus, the transmission efficiently of the light emitted from the backlight is improved, increasing brightness and display quality and reducing electrical power consumption.

For the display element according to an embodiment of the present invention, it is desirable that the directionality is oriented toward the viewing direction of the display element.

The angle of the emitted light can be set in accordance with the range of the user's viewing angle. Thus, when the display element is installed in a mobile apparatus, the visibility of the display surface for the user is significantly improved.

It is desirable that the light emitted from the backlight is transmitted through the liquid crystal display panel at an angle within a range of −10° to 30° with respect to the normal line to each of the light-reflecting display units or with respect to the display surface of the liquid crystal display panel.

By setting the transmitted light within the range indicated above, the settings of the display element can be matched with the user's viewing angle.

The display element may be structured so that focusing means are interposed between the liquid crystal display panel and the backlight in a manner such that the positions of the focusing means corresponds to positions of the pixel electrodes, the focal axis of each the focusing means is disposed at an offset position parallel to the normal line to the center of each of the light-transmitting display units, and the light emitted from the backlight is focused by each of the focusing means and is focused at a focal point at the center of each of the light-transmitting display units.

The display element may be structured so that focusing means is interposed between the liquid crystal display panel and the backlight in a manner such that the positions of the focusing means correspond to the positions of the pixel electrodes. The focal axis of the focusing means is disposed at an inclined position with an offset angle with respect to the normal line to the center of each of the light-transmitting display units. The light emitted from the backlight is focused by each of the focusing means and is focused at a focal point at the center of each of the light-transmitting display units.

Light emitted from the backlight can be transmitted through the liquid crystal display panel as light having a predetermined angle with respect to the normal line to each of the light-transmitting display units or the display surface of the liquid crystal display panel. Thus, visibility of the display element viewed by the user is significantly improved.

For the display element the percentage of the area of the light-transmitting display unit to the area of the pixel electrode is desirably within a range of about 5% to 90% and, more desirably, within a range of about 10% to 80%.

By setting the percentage of the area of the light-transmitting display unit to the area of the pixel electrode is within the above range, the brightness of the display element is increased.

For the display element light emitted from the backlight is desirably emitted at an angle within a range of about −20° to 20° and, more desirably, about −10° to 10°, with respect to the normal line of the emission surface of the backlight.

By setting the angle of the emitted light within the above range with respect to the normal line of the emission surface of the backlight, the transmission of the light of the liquid crystal display panel is improved even more.

For the display element the focusing means may be provided on the lower surface of the second substrate of the liquid crystal display panel.

For the display element the focusing means may be a microlens array, a lenticular lens, Fresnel lens, or gradient index lens.

An electronic apparatus including the above-described display element is provided.

When a display element is installed in an electronic apparatus, such as a mobile apparatus, the visibility of the display surface viewed by the user is significantly improved.

A method of producing a display element is provided. The display element includes a liquid crystal display panel having liquid crystal sealed between first and second substrates. The first and second substrates disposed opposite to each other and a backlight that illuminates the liquid crystal display panel. Electrodes and an alignment film are provided on the liquid crystal layer side of the first substrate and the liquid crystal layer side of the second substrate. Some of the electrodes on the second substrate are light-reflecting pixel electrodes. A light-transiting portion is formed on part of each of the pixel electrodes. Light-transmitting display units are formed by providing transparent electrodes in the areas where the light-transiting portions are formed, wherein areas where light-reflecting pixel electrodes are provided function as light-reflecting display units. The backlight is disposed on the second substrate side, wherein a microlens array is interposed between the liquid crystal display panel and the backlight in a manner such that the positions of microlenses of the microlens array correspond to positions of the pixel electrodes. The focal axis of each of the microlenses is disposed at an offset position parallel to the normal line to the center of each of the light-transmitting display units or at an inclined position with an offset angle. The light emitted from the backlight is focused by each of the microlenses and is focused at a focal point at the center of each of the light-transmitting display units.

The method includes producing the microlens array by carrying out mask exposure to a material whose photosensitivity and refraction index change after applying the material to the backlight side surface of the second substrate.

A method of producing a display element that includes a liquid crystal display panel having liquid crystal sealed between first and second substrates. The first and second substrates being disposed opposite to each other. A backlight illuminates the liquid crystal display panel. Electrodes and an alignment film are provided on the liquid crystal layer side of the first substrate and the liquid crystal layer side of the second substrate. Some of the electrodes on the second substrate are light-reflecting pixel electrodes. A light-transiting portion is formed on part of each of the pixel electrodes. Light-transmitting display units are formed by providing transparent electrodes in the areas where the light-transiting portions are formed. Areas where light-reflecting pixel electrodes are provided function as light-reflecting display units. The backlight is disposed on the second substrate side. A microlens array is interposed between the liquid crystal display panel and the backlight in a manner such that the positions of microlenses of the microlens array correspond to positions of the pixel electrodes. The focal axis of each of the microlenses is disposed at an offset position parallel to the normal line to the center of each of the light-transmitting display units or at an inclined position with an offset angle. The light emitted from the backlight is focused by each of the microlenses and is focused at a focal point at the center of each of the light-transmitting display units.

The method includes producing the microlens array by applying transparent resin to the backlight side surface of the second substrate by inkjet application.

A display element is structured so that light emitted from the backlight is transmitting through the liquid crystal display panel with directionality in a predetermined angle with respect to the normal line of each of the light-transmitting display units or the display surface of the liquid crystal display panel.

The angle of the light emitted from the liquid crystal display panel can be set within the viewing angle of the user viewing the display element.

The transmission efficiency of the light emitted from the backlight is increased, increasing brightness and display quality and reducing electrical power consumption. When the display element is installed in a mobile apparatus, the visibility of the display surface for the user is significantly improved.

The display element may be structured so that focusing means is interposed between the liquid crystal display panel and the backlight in a manner such that the positions of the focusing means correspond to positions of the pixel electrodes, the focal axis of each the focusing means is disposed at an offset position parallel to the normal line to the center of each of the light-transmitting display units or at an inclined position with an offset angle with respect to the normal line to the center of each of the light-transmitting display units, and the light emitted from the backlight is focused by each of the focusing means and is focused at a focal point at the center of each of the light-transmitting display units provided in each pixel of the liquid crystal display panel.

Light emitted from the backlight and focused by the focusing means can be transmitted through the liquid crystal display panel at a predetermined angle with respect to the normal line to each of the light-transmitting display units or the display surface of the liquid crystal display panel. Accordingly, the visibility of the display surface for the user is significantly improved.

### BRIEF DESCRIPTION OF THE DRAWINGS

FIG. 1 illustrates a cross-sectional view of a display element;

FIG. 2 illustrates a schematic view of a display element;

FIG. 3 illustrates a schematic view of a display element, wherein FIG. 3A illustrates a plan view, FIG. 3B illustrates a cross-sectional view taken along line IIIB-IIIB in FIG. 3A, and FIGS. 3C to 3E illustrates cross-sectional views taken along line IIIC-IIIC in FIG. 3A;

FIG. 4 illustrates a display element, wherein FIG. 4A illustrates a partially enlarged view and FIG. 4B illustrates a schematic view of the lens characteristic;

FIG. 5 illustrates a display element, wherein FIG. 5A illustrates a partially enlarged view and FIG. 5B illustrates a schematic view of a viewing angle of a user viewing the display element;

FIG. 6 illustrates the production process of the display element by forming a microlens array;

FIG. 7 illustrates the production process of the display element by forming a microlens array;

FIG. 8 illustrates a schematic view of a display element;

FIG. 9 illustrates a schematic view of the structure of a backlight according the display element;

FIG. 10 illustrates a graph representing the brightness-angle distribution of a backlight;

FIG. 11 illustrates an example display element, wherein FIG. 11A illustrates a graph representing transmission and FIG. 11B illustrates a list of exemplary transmission data;

FIG. 12 illustrates an example display element and data on a backlight including a prism sheet;

FIG. 13 illustrates an example display element and data on a backlight including a prism sheet;

FIG. 14 illustrates an example display element and data on a backlight including a prism sheet;

FIG. 15 illustrates an example display element and data on a backlight including a prism sheet;

FIG. 16 illustrates an example display element and data on a backlight including a prism sheet; and

FIG. 17 illustrates a display element and the relationship between the angle of a backlight reflecting plate and the reflection angle.

### DESCRIPTION

A display element will be described below with reference to the drawings.

In all drawings referred to in the descriptions below, the thickness and size ratio of each component are changed appropriately to simplify the descriptions.

### FIRST EMBODIMENT

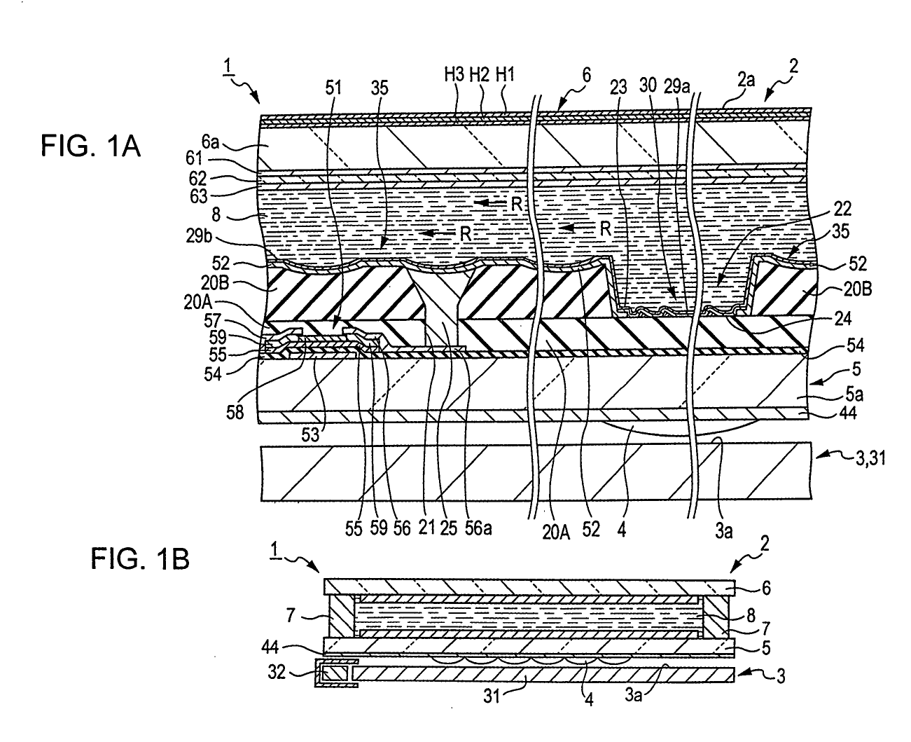

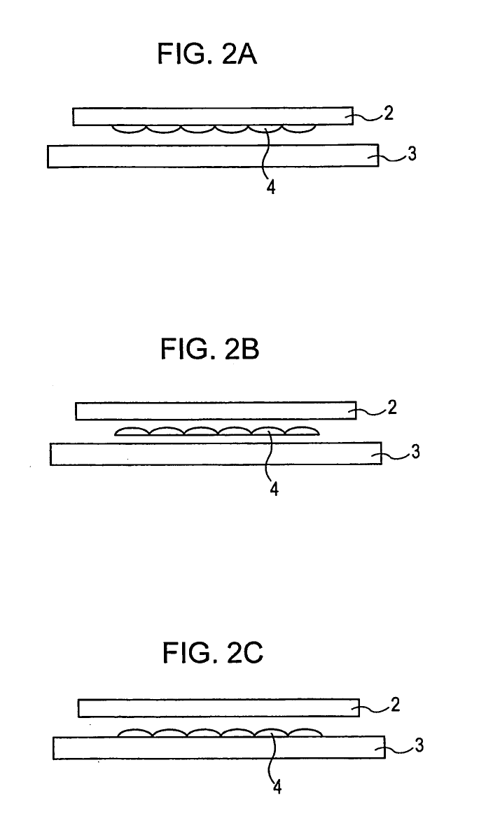

FIGS. 1A, 1B, 2A, 2B, and 2C illustrate a display element 1. The display element 1 includes a liquid crystal display panel 2. A backlight 3 illuminates the liquid crystal display panel 2 from the back side. A microlens array (focusing means) 4 is interposed between the liquid crystal display panel 2 and the backlight 3. Light emitted from the backlight 3 is transmitted through the liquid crystal display panel 2. This transmitted light is emitted with directionality from the liquid crystal display panel 2 at a predetermined angle with respect to the normal line to each transparent electrode (light-transmitting display unit) 24 of the liquid crystal display panel 2 or a display surface 2a of the liquid crystal display panel 2.

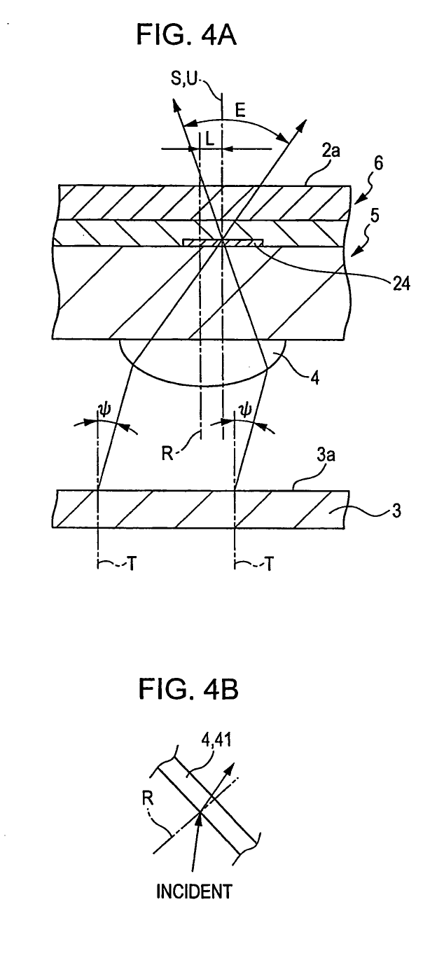

The display element 1 according to this embodiment is structured so that the light emitted from the backlight 3 is transmitted through the liquid crystal display panel 2 at an angle E with respect to the normal line to each of the transparent electrodes 24 or the display surface 2a of the liquid crystal display panel 2, wherein the angle E is within a range of about −10° to 30° (refer to FIG. 4A).

As shown in FIG. 1A, the microlens array 4 included in the display element 1 according to this embodiment focuses light emitted from the backlight 3 at each of the transparent electrodes (light-transmitting display units) 24 provided inside each pixel electrode 52 in the liquid crystal display panel 2 at a focal point at the center of each transparent electrode 24.

As shown in FIG. 4A, in the display element 1, a lens axis (focal axis) R of each microlens in the microlens array 4 is disposed at a position displaced parallel to the normal line S of the center of the transparent electrode 24 by an offset length L.

The percentage of the area of the transparent electrodes 24 in the display element 1 to the area of the pixel electrodes 52 is within the range of is about 5% to 90% or, more desirably, about 10% to 80%.

The display element 1 according to this embodiment emits light from the backlight 3 at an average emission angle ψ with respect to the normal line T of an light-emitting surface 3a of the backlight 3, wherein the average emission angle ψ is within the range of about −20° to 20° or, more desirably, about −10° to 10°.

As shown in the schematic views in FIGS. 1A and 1B, the liquid crystal display panel 2 includes an active matrix substrate (lower substrate, second substrate) 5 provided on the same side as a switching element, an opposing substrate (upper substrate, first substrate) 6 provided opposite to the active matrix substrate 5. A liquid crystal layer 8, which functions as a light modulating layer, is interposed between the active matrix substrate 5 and the opposing substrate 6 so that the liquid crystal layer 8 is surrounded by the active matrix substrate 5, the opposing substrate 6, and a sealing material 7. The substrates 5 and 6, structured as described above, are held predetermined distance apart by spacers (not shown in the drawings) and are bonded into a unit by applying the thermosetting sealing material 7 to the peripheries of the substrates.

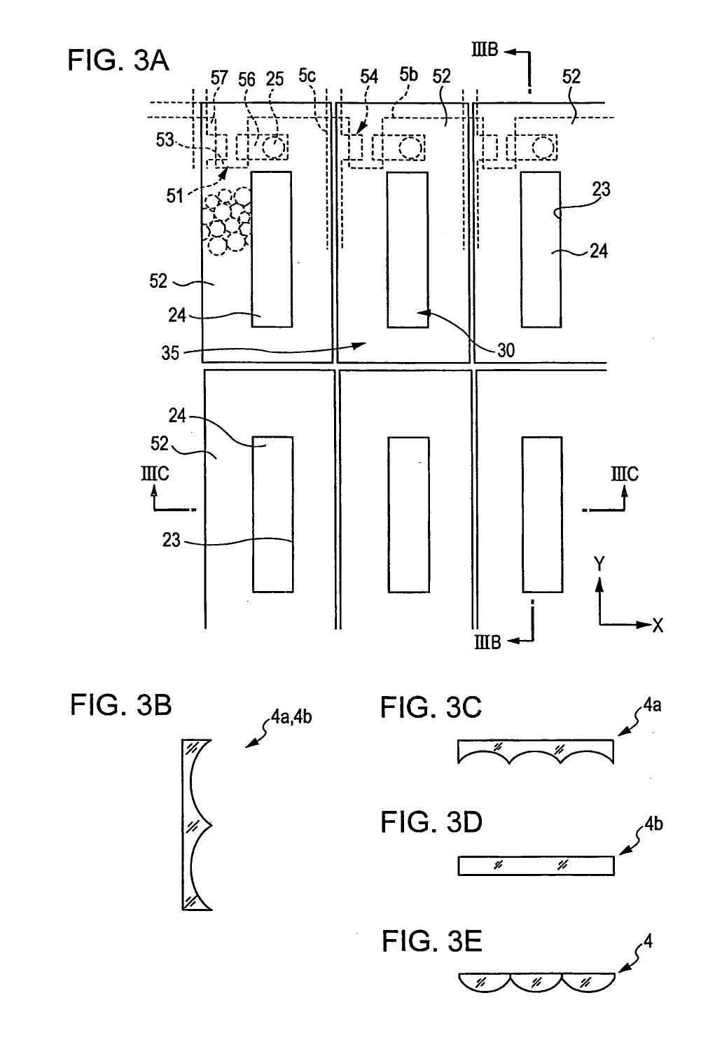

As shown in FIGS. 1A, 1B, and 3A, the active matrix substrate 5 is constructed by providing scanning lines 5b and signal lines 5c, which are electrically insulated from each other, in the horizontal direction (i.e., x direction in FIG. 3A) and the vertical direction (i.e., y direction in FIG. 3A), respectively, when viewed from the top, on a transparent substrate body 5a consisting of glass or plastic. TFTs (switching elements) 51 are provided near the intersections of the scanning lines 5b and the signal lines 5c. In the transparent substrate body 5a, the areas where the pixel electrodes 52 are provided, the areas where the TFTs 51 are provided, and the areas where the scanning lines 5b and the signal lines 5c are provided are referred to as pixel areas, element areas, and wiring areas, respectively.

Each of the TFTs 51 according to this embodiment has an inverse staggered structure. The TFT 51 is constructed by providing the transparent substrate body 5a, which is the main body of the TFTs 51, as the lowest layer, and then stacking a gate electrode 53, a gate insulating film 54, an i-type semiconductor layer 55, a source electrode 56, and a drain electrode 57 in this order. An etching stopper layer 58 is provided on the i-type semiconductor layer 55 and between the source electrode 56 and the drain electrode 57. N-type semiconductor layers 59 are provided between the i-type semiconductor layer 55 and the drain electrode 57 and between the i-type semiconductor layer 55 and the source electrode 56.

The transparent substrate body 5a includes an insulating transparent substrate consisting of glass or synthetic resin. The gate electrode 53 consists of a conductive metal material and is provided as a unit with the scanning lines 5b disposed in the horizontal direction, as shown in FIG. 3A. The gate insulating film 54 includes a silicon-based insulating film consisting of silicon oxide (SiOx) or silicon nitride (SiNy). The gate insulating film 54 is disposed on the substrate and covers the scanning lines 5b and the gate electrode 53.

The TFTs 51, structured as described above, and a source insulating film 20A covering the scanning lines 5b and the signal lines 5c are provided on the transparent substrate body 5a.

Inverse staggered type TFTs 51 are provided as switching elements. However, other types of switching elements, such as TFTs having a different laminated structure or thin film diode elements, may be used.

An insulating film 20B consisting of an organic material is stacked on the source insulating film 20A. On this insulating film 20B, the reflective pixel electrodes 52 consisting of a highly reflective metal material, such as aluminum (Al) or silver (Ag), are provided.

The reflective pixel electrodes 52 are provided on the insulating film 20B so that, when viewed from the top, the shape of each of the pixel electrodes 52 is a rectangle slightly smaller than each of the rectangular areas surrounded by the scanning lines 5b and the signal lines 5c. As shown in FIG. 3A, the pixel electrodes 52 are disposed at a predetermined distance apart from each other in a matrix, so that short-circuiting of adjacent pixel electrodes 52, is prevented. More specifically, each of the pixel electrodes 52 is disposed in a manner such that the edges of the pixel electrode 52 are disposed along the scanning line 5b and the signal line 5c provided below the pixel electrode 52. Most of the area defined by the scanning line 5b and the signal line 5c functions as a pixel area. The collection of all pixel areas together corresponds to the display area of the liquid crystal display panel 2.

The insulating film 20B is an organic insulating film consisting of acryl-based resin, polyimide-based resin, or benzocyclobutene (BCB) polymer. The insulating film 20B is provided to increase the protection of the TFTs 51. The thickness of the insulating film 20B stacked on the transparent substrate body 5a is relatively greater than that of the other layers. The pixel electrodes 52, the TFTs 51, and the various electrical lines are reliably insulated. The insulating film 20B also prevents the generation of a great parasitic capacitance between the pixel electrodes 52.

In the above-described insulating films 20A and 20B, contact holes 21 that reach ends 56a of the source electrodes 56 are formed. Inside each contact hole 21, a connection part 25 consisting of a conductive material is provided so as to electrically connect the pixel electrode 52 and the end 56a of the source electrode 56 provided above and below, respectively, of the contact hole 21. In accordance with the operation of each of the TFTs 51, the connection part 25 can switch the electrical power applied to the pixel electrode 52.

In the insulating film 20B, depressions 22, each having a rectangular shape when viewed from the top, are provided at the central areas of the rectangular areas surrounded by the scanning lines 5b and the signal lines 5c. The depressions 22 are formed so that they penetrate through the insulating film 20B and reach the source insulating film 20A. The planar size of each depression 22 is desirably set so that the horizontal width is a fraction of that of each pixel electrode 52 and the vertical width is about 50% to 60% of that of the pixel electrode 52. The planar area of the depression 22 is desirably about 5% to 90%, or more desirably about 10% to 80%, of the area of the pixel electrode 52.

At the area of the pixel electrode 52 that corresponds to the depression 22, a flat transmissive portion (transmission hole) 23 that matches the shape of the bottom surface of the depression 22 is provided. A transparent (pixel) electrode 24 consisting of a transparent electrode material is provided, so that the bottom surface of the depression 22 at the lower side of the transmissive portion 23 of the pixel electrode 52 is covered.

The reflective pixel electrode 52 is electrically connected to the transparent electrode 24 by the pixel electrode material that extends to cover the inner circumference of the depression 22 and to reach the peripheral area of the transparent electrode 24 at the bottom surface of the depression 22. Thus, the reflective pixel electrode 52 and the transparent electrode 24 are capable of driving the liquid crystal layer by being driven simultaneously by the switching operation of the TFT 51 to apply an electrical field to the liquid crystal layer.

Accordingly, in each pixel area, the area of the depression 22 corresponds to a transmissive portion 30 that transmits light from the outside of the active matrix substrate 5 (i.e., light emitted from the backlight 3). The other area, for example, the non-transmissive portion of the pixel electrode 52 (or the area where the transmissive portion 23 is not provided), corresponds to a reflective display portion 35 that reflects light from the outside of the opposing substrate 6.

Since three reflective pixel electrodes 52 substantially correspond to one pixel area for color display, which is described below, and the bottom areas of the transmissive portions 23 correspond to the light-transmitting area for transmissive display, the area of each transmissive portion 23 is desirably set to about 5% to 90%, or more desirably to about 10% to 80%, of the area of each pixel electrode 52. According to this embodiment, only one transmissive portion 23 is provided for each pixel electrode 52. However, a plurality of transmissive portions may be provided for each pixel electrode 52. In such a case, the area of each transmissive portion is desirably set to about 5% to 90%, or more desirably to about 10% to 80%, of the area of each pixel electrode 52. In such a case, the depressions are formed at positions below the transmissive portions.

As described above, on the transparent substrate body 5a, alignment films 29a and 29b consisting of polyimide are provided on the lower substrate side so as to cover the pixel electrodes 52, the insulating film 20B, the depressions 22. The alignment film 29a is provided on the transmissive portions 30, for example, the bottom of the depressions 22, whereas the alignment film 29b is provided on the pixel electrodes 52.

The alignment films 29a and 29b are rubbed in the direction indicated by arrows R in FIG. 1A (leftward in the cross-sectional view shown in FIG. 1A). Thus, the easy-alignment axis of the liquid crystal is matched with the direction indicated by the arrows R. Moreover, the pre-tilt angle is desirably set over about 0° and up to about 10°, for example, within the range of approximately 1° to approximately 10°, or more desirably within the range of about 5° to about 10°.

A color filter layer 61, a transparent opposing electrode (common electrode) 62 consisting of indium tin oxide (ITO), and an upper substrate side alignment film 63 is provided on a transparent substrate body 6a, which consists of glass or plastic, of the opposing substrate 6 on the side of the liquid crystal layer 8. As shown in FIG. 1A, a polarizing plate H1 and retardation plates H2 and H3 are provided on the outer surface of the transparent substrate body 6a, if required. On the color filter layer 61, a color picture element of one of the three primary colors, for example, red, blue, and green, is disposed in each rectangular area arranged in a grid by a black matrix. The rectangular areas correspond to the pixel electrodes 52 that are also rectangular when viewed from the top, as described with reference to FIG. 3A. The corresponding pixel electrodes 52 adjust the transmission of the liquid crystal in the corresponding areas and enable color display.

The thickness of the alignment films 63 and 29b is, for example, about 500 to 600 angstroms (0.05 to 0.06 μm).

As shown in FIG. 1A, the backlight 3 is disposed on the back side, for example, the side of the active matrix substrate 5, of the liquid crystal display panel 2. As shown in FIG. 1B, the backlight 3 includes a light source 32 including a light-emitting diode (LED) and a light-guiding plate 31 consisting of flat transparent acrylic resin. Light emitted from the light source 32 enters the end surface of the light-guiding plate 31 and is transmitted through and emitted from the front surface of the light-guiding plate 31. In this way, the liquid crystal display panel 2 is illuminated from the back side.

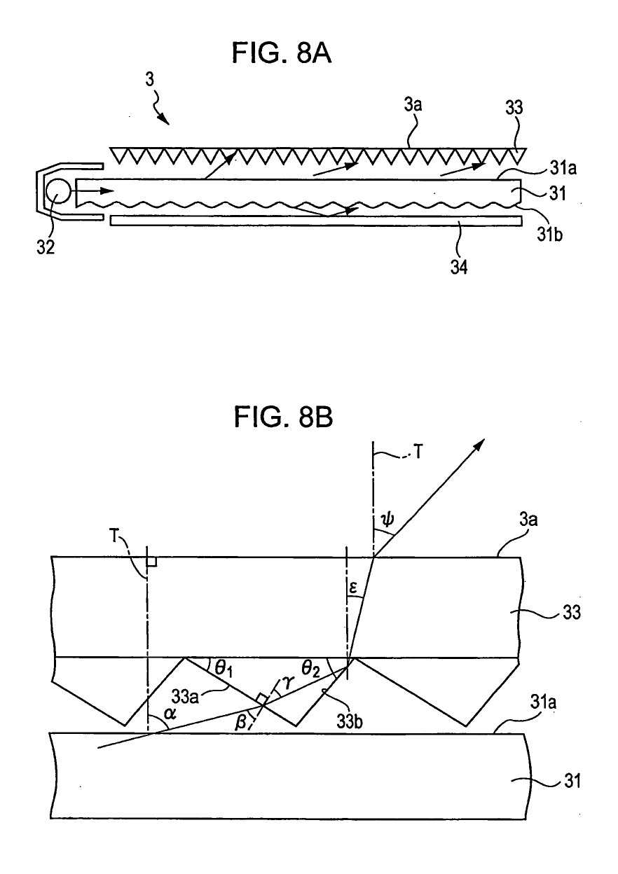

As shown in FIG. 8, the light-guiding plate 31 changes the light path at the light-reflecting area constructed of prism-shaped bumps provided on the back surface, for example, the surface opposite to the liquid crystal display panel 2. Then, the light is reflected at a reflecting plate 34 and is emitted from a front surface 31a on the upper side of the light-guiding plate 31 toward the liquid crystal display panel 2.

A prism sheet 33 including prisms formed of triangular bumps is provided on the front surface 31a side of the light-guiding plate 31. The prism sheet 33 includes a plurality of protruding refraction portions consisting of refracting surfaces 33a and reflecting surfaces 33b provided on the side of the incident surface, for example, the side of the light-guiding plate 31. The prism sheet 33 also includes the flat light-emitting surface 3a provided opposite to the incident surface. Light is emitted from the light-emitting surface 3a toward the liquid crystal display panel 2.

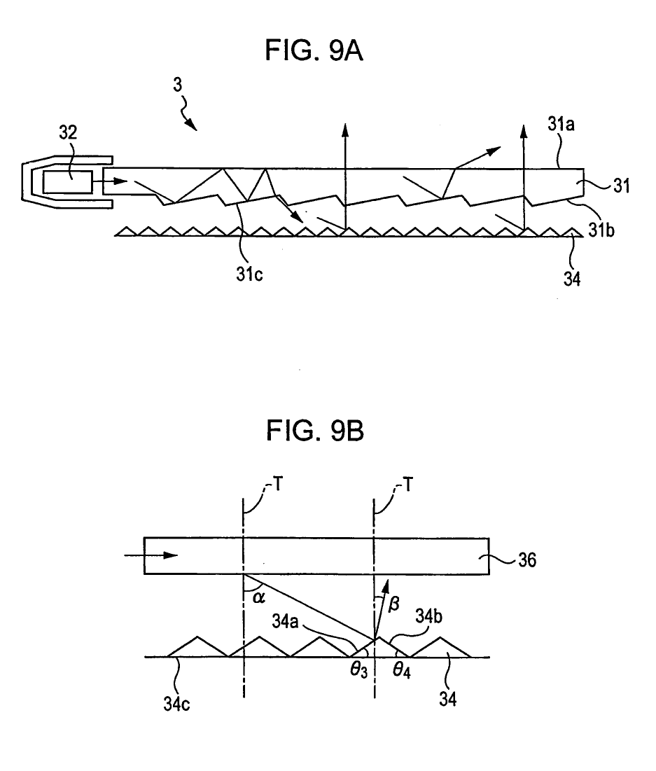

As shown in FIG. 9, on the side of a back surface 31b of the light-guiding plate 31, reflecting surfaces 34a and 34b are provided as triangular bumps. Therefore, even when the reflecting plate 34 that reflects the light emitted from the back surface 31b of the light-guiding plate 31 toward the light-guiding plate 31 is provided, collimated light can be emitted.

If required, a polarizing plate 44 (refer to FIG. 1A) and a retardation plate (not shown in the drawings) are interposed between the backlight 3 and the liquid crystal display panel 2.

By employing the above-described structure, the display element 1 according to this embodiment is capable of collimating the light emitted from the light-emitting surface 3a of the backlight 3.

The light emitted from the backlight 3 can be maintained at a constant angle by setting the two inclination angles θ₁ and θ₂ of each prism in accordance with the angle α of the light emitted from the surface 31a of the light-guiding plate 31 of the backlight 3 with respect to the normal line T. The inclination angle θ₁ is the angle of inclination with respect to the light-emitting surface 3a of the refracting surfaces 33a of the prism sheet 33. The inclination angle θ₂ is the angle of inclination with respect to the light-emitting surface 3a of the reflecting surfaces 33b.

The setting conditions of the inclination angles of the prism sheet 33 of backlight 3, as illustrated in FIG. 8, will be described below.

The angles β, γ, ε, and ψ, shown in FIG. 8B, are represented by Expressions 2 to 5 below when the reflective index of the prism sheet 33 is n. The angle β represents the angle of emitted light with respect to the normal line to the refracting surfaces 33a. The angle γ represents the angle of transmitted light with respect to the normal line to the refracting surfaces 33a. The angle ε represents the angle of reflected light with respect to the normal line T to the refracting surfaces 33a. The angle ψ represents the angle of average emission light from the light-emitting surface 3a with respect to the normal line T.
β=α−θ₁ (2)
γ=sin⁻¹ (sin β/n) (3)
ε=180−2θ₂θ₁−γ (4)
ψ=sin⁻¹ (n×sin ε) (5)

For the angles represented above, if ψ=ε=0, the inclination angles θ₁ and θ₂ are represented by Expression 1 below.
θ₂=½(180−θ₁−sin⁻¹ (sin (α−θ₁)/n) (1)

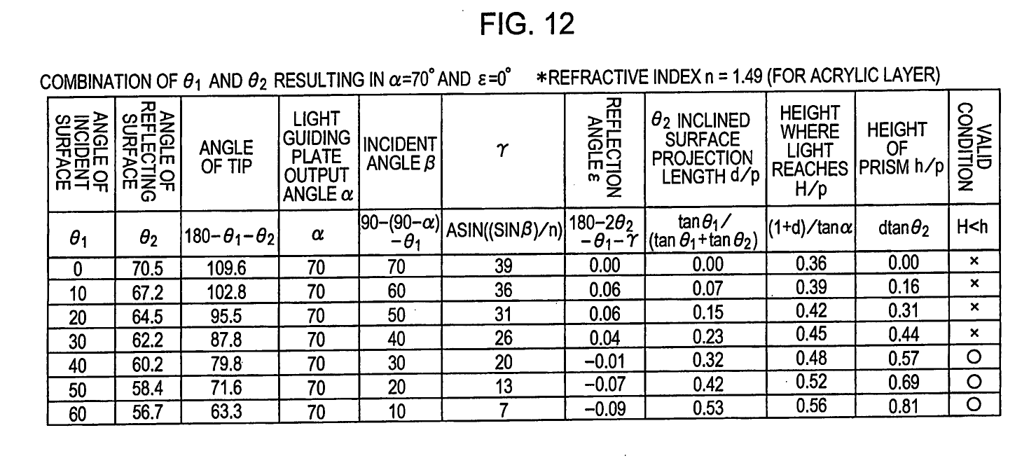

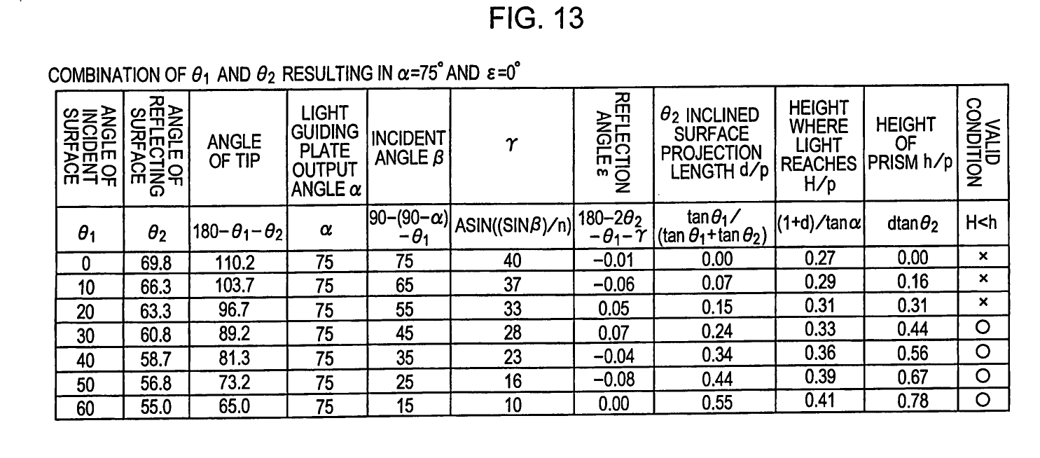

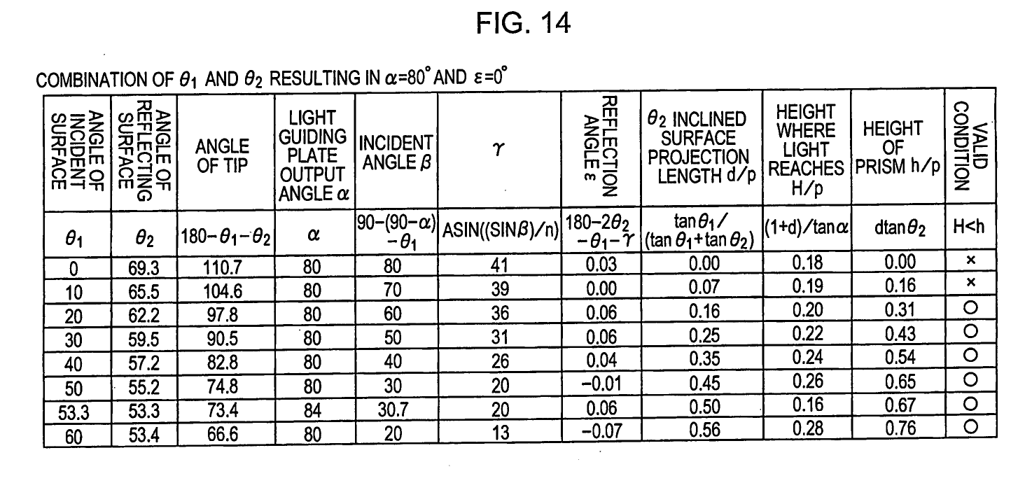

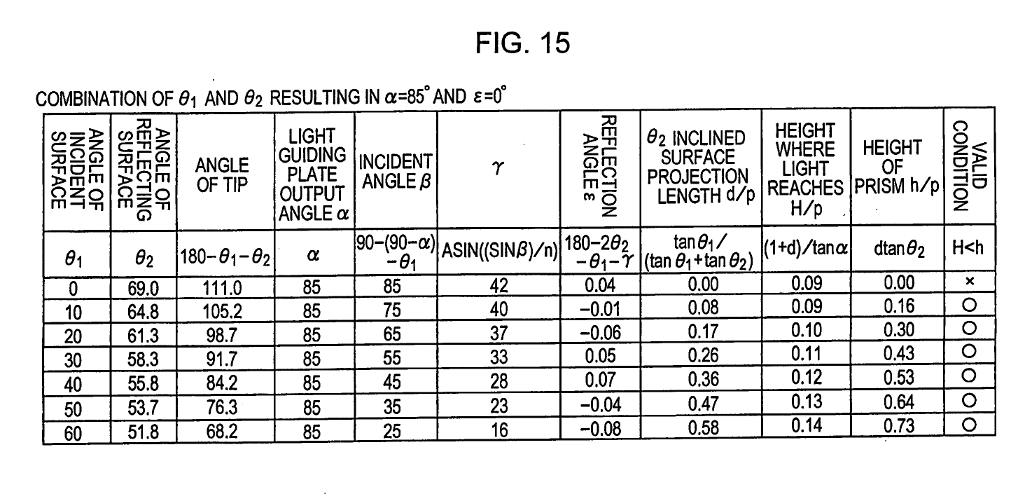

It is desirable to set the inclination angle θ₁ to θ₁>30° if α=70°, θ₁>20° if α=75°, θ₁>10° if α=80°, and θ₁>0° if α=85° (refer to FIGS. 12 to 15). The range of the inclination angle θ₂ is uniquely determined on the basis of α and θ₁.

By setting the angles ψ and ε to 0°, setting the inclination angle θ₁ within the above-identified range when the angle α is set as above, and uniquely determining the inclination angle θ₂, the diffusion angle of the light emitted from the backlight 3 with respect to the normal line T is set within the range of about −20° to about 20°, or more desirably about −10° to about 10°. Thus, the emitted light is substantially collimated, and the use efficiency of the emitted light is increased.

Details on the desirable ranges of the inclination angles θ₁ and θ₂ will be described in the examples below with reference to data.

The setting conditions of the inclination angles of the reflecting plate 34 disposed on the side of the back surface 31b of the backlight 3 will be described below.

As shown in FIG. 9B, the relationship between the angle α of the light emitted from the light-guiding plate 31 with respect to the normal line T and the angle β of the light reflected when the light emitted from the light-guiding plate 31 is reflected at the reflecting surface 34a is determined on the basis of an inclination angle θ₃ of the reflecting surface 34a of a bottom surface 34c by applying Expression 6. It is desirable that an inclination angle θ₄ of the reflecting surface 34b, which opposes the bottom surface 34c, satisfies Expression 7 below.
θ₃=(α−β)/2 (6)
90−α<θ₄≦90° (7)

As shown in FIG. 9A, inclined portions 31c smoothly inclined against the light-emitting direction of the light source 32 are provided on the back surface 31b of the light-guiding plate 31.

According to the structure of the display element 1 according to this embodiment, light emitted from the light source 32 is emitted from the inclined portions 31c of the light-guiding plate 31, reflected at the reflecting plates 34, perpendicularly emitted at and transmitted through the light-guiding plate 31, and emitted from the surface 31a of the light-guiding plate 31.

The inclination angle θ₃ is uniquely determined on the basis of the angles α and β. It is desirable to set the inclination angle θ₄ within the range of 90°−α≦θ₄≦90°.

By setting the inclination angles θ₃ and θ₄ as indicated above, light emitted from the back side of the backlight 3 is efficiently reflected at the reflecting plate 34 toward the backlight 3. Thus, the light can be emitted from the light-emitting surface 3a of the backlight 3.

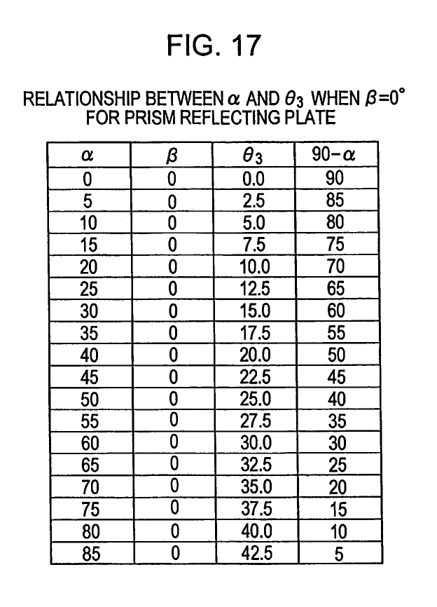

FIG. 17 shows the relationship between the angle α and the inclination angle θ₃ when the angle β equals 0°, i.e., when the angle β is parallel to the normal line of the backlight 3. The larger the inclination angle α is, the greater the inclination angle θ₃ is, causing the desirable range of the inclination angle θ₄, represented by Expression 7, to become greater.

By setting the inclination angles θ₁ and θ₂ on the basis of Expressions 2 to 5, the average emission angle ψ of the light emitted from the light-emitting surface 3a of the backlight 3 with respect to the normal line T can be set appropriately.

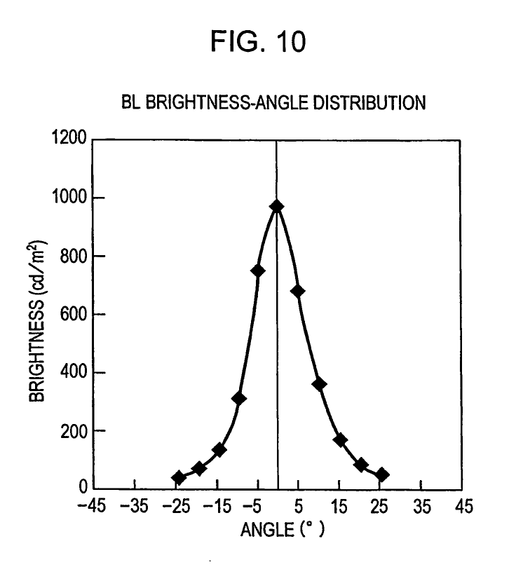

The graph illustrated in FIG. 10 represents the measurement results of the brightness-angle distribution of a backlight according to an example, such as that shown in FIG. 8.

The backlight used for the measurement was set, so that the angle α of the light emitted from the light-guiding plate 31 with respect to the normal line T was about 75° and the refraction index n of the prism sheet 33 was about 1.49. The inclination angles θ₁ and θ₂ of the prisms of the prism sheet 33 of this backlight were set to θ₁=50° and θ₂=56.8° on the basis of Expression 1, so that a beam of light whose reflection angle ε of the reflecting surfaces 33b with respect to the normal line T and the average emission angle ψ from the light-emitting surface 3a with respect to the normal line T were both set to 0° was emitted from the light-emitting surface 3a.

As shown in the graph illustrated in FIG. 10, the peak brightness of the backlight described in this example at a 0° angle with respect to the normal line T was about 1,000 cd/m². The brightness at a −10° angle and a 10° angle with respect to the normal line T was about 350 cd/m², and the brightness at a −20° angle and a 20° angle with respect to the normal line T was about 100 cd/m². The brightness within this range was greater than about 100 cd/m².

In contrast, the brightness at about −25° angle and about 25° angle with respect to the normal line T was about 30 cd/M². This was smaller than the brightness within the range of −20° to 20°.

According to the brightness-angle distribution graph, for the backlight used in this example, the range in which the highest brightness was achieved was substantially within the range of −20° to 20° or, more desirably −10° to 10°, with respect to the normal line T. Thus, the backlight was capable of emitting well-collimated light beams.

Even when a backlight including a prismatic reflecting plate 34 on the back side of the light-guiding plate 31 is used, well-collimated light beams, similar to that obtained above, are emitted.

According to the display element 1 according to this example, by employing a backlight having the above-described structure, the angle of the light emitted from the backlight was set within the range of about −20° to about 20° or, more desirably about −10° to about 10°. In this way, light emitted from the backlight can be efficiently focused at the microlenses included in the microlens array 4, described below. Thus, the brightness of the display element 1 can be increased.

The microlens array 4 is interposed between the liquid crystal display panel 2 and the backlight 3. The microlens array 4 focuses the light emitted from the backlight 3 and emits the focused light onto the transparent electrodes (light-transmitting display units) 24 of the liquid crystal display panel 2.

As shown in FIG. 4A, according to this embodiment, each microlens of the microlens array 4 is set such that the lens axis R is displaced parallel to a normal line S to the center of each transparent electrode 24 by an offset length L.

As shown in FIGS. 2A and 2C, the microlens array 4 may be provided on the back side (i.e., polarizing plate 44 side) of the substrate body 5a on which the TFTs 51 are mounted or may be provided on the surface of the light-guiding plate 31 of the backlight 3. Instead, as shown in FIG. 2C, the microlens array 4 may be interposed between the substrate body 5a and the light-guiding plate 31. In other words, the position of the microlens array 4 may be selected appropriately.

The lens shape of the microlens array 4 is not limited to that shown in FIG. 2.

The cross-sectional views in FIGS. 3B to 3E show how the pixel electrodes 52, shown in FIG. 3A, correspond to the microlenses.

The microlens array 4 may be an array of convex lenses, as shown in the cross-sectional view of FIG. 3E. Instead, for example, the microlens array 4 may be an array of concave lenses, as shown in both cross-sectional views in FIGS. 3B and 3C.

The microlens array may include a plurality of lenses corresponding to the pixel electrodes 52 shown in FIG. 3A. Instead, the microlens array 4 may have a shape that combines the cross-sectional views of FIGS. 3B and 3D. The microlens array also may be a microlens array 4b including a lenticular lens constructed of an array of lens capable of focusing light in only the longitudinal direction of the pixel electrodes 52.

Fresnel lenses or gradient index glass may be used to focus light onto each pixel.

If the microlens array 4 is to be provided on the back side of the substrate body 5a before providing the TFTs 51 on the substrate body 5a, it is desirable to select a material for the microlens array 4 that does not deform during the production and processing of the TFTs 51.

When bonding a polarizing plate on the back side (backlight 3 side) of the substrate body 5a while forming the microlens array 4 on the substrate body 5a, it is desirable to select an adhesive that has a refraction index that is closest to one. In this way, the refraction of the lens is decreased, and the focal length in increased.

After providing gradient index glass at a position corresponding to the pixel electrodes 52 on the back side of the substrate body 5a, the TFTs 51 may be formed on the surface on the opposite side.

When providing the lenses on the back side of the substrate body 5a after forming the TFTs 51 on the substrate body 5a, care must be exercised to prevent the alignment film from being degraded by processing, such as spin coating or wet development.

As shown in FIG. 2A, it is desirable to dispose the microlens array 4 in a manner such that it is not disposed closely and directly below the transparent electrodes 24 when providing the microlens array 4 on the back side of the liquid crystal display panel 2, for example, on the back side of the substrate body 5a. In this way, the focal length of the microlens array 4 is increased, allowing lenses having small amplitude to be used and the flattening process of the microlens array 4 to be omitted.

It is desirable to disposed the microlens array 4 in such a manner because, when the microlens array 4 is disposed closely and directly below the transparent electrode 24: 1) a microlens array having great amplitude that is difficult to produce may be required because the focal distance becomes small; 2) a flattening process may be required to be carried out on the microlens array (wherein the thickness of the film to be flattened must be 10 μm or greater); 3) the material used for producing the film to be flattened may be limited to a material that is resistive to heat higher than 200° C. and that has a low refractive index of about 1.3 or smaller; and 4) reliability and yield may be reduced when metal wires and the TFTs 51 are provided on the flattened film.

For the display element 1 according to this embodiment, by employing the microlens array 4 having the above-described structure, light emitted from the backlight 3 can be efficiently focused at the center of each transparent electrode 24 even when the beams of light from the backlight 3 are tilted and emitted to the microlenses of the microlens array 4.

As shown in FIG. 4A, for example, even if the light from the backlight 3 does not enter the microlenses of the microlens array 4 as collimated light but enters at a diffused angle, the refracting effect and focusing effect of the microlens array 4, as shown in FIG. 4B, enables light to be efficiently focused at the center of each transparent electrode 24.

For the display element 1 according to this embodiment, by employing the backlight 3 having the above-described structure, the light from the backlight 3 can be emitted as directional light having a diffusion angle within the range of about 20° to about −20°, or more desirably about 10° to about −10°, with respect to the normal line to the light-emitting surface of the backlight 3 (refer to FIG. 10). Thus, the light emitted from the backlight 3 and focused at the microlens array 4 can be efficiently transmitted to the center of each transparent electrode 24.

As shown in FIG. 4A, if the angle ψ of the emitted light with respect to the normal line T of the light-emitting surface 3a of the backlight 3 is within the range of about 10° to about −10°. The microlenses of the microlens array 4 disposed at offset positions are capable of efficiently focusing light at the center of each transparent electrode 24.

If the angle ψ of the emitted light with respect to the normal line T of the light-emitting surface 3a of the backlight 3 is not within the range of about 10° to about −10°, light may not be efficiently focused at the center of each transparent electrodes 24, causing a reduction in the brightness of the display element 1. To efficiently irradiate the transparent electrodes 24 with the emitted light, the offset amount of the microlenses of the microlens array 4 must be increased, causing an increase in production cost of the display element 1.

For the display element 1 according to this embodiment, by appropriately setting the above-described offset length L, an angle E of the emitted light with respect to the normal line S of each transparent electrode 24 or the normal line U of the display surface 2a while light emitted from the backlight 3 and focused by the microlens array 4 is transmitted through the transparent electrode 24 and emitted from the display surface 2a of the liquid crystal display panel 2 is set within the range of about −10° to about 30°. In this way, the visibility of the display surface (i.e., the display surface of the display element 1) viewed by a user is significantly increased when the display element 1 is used as a display unit of a mobile apparatus (electronic apparatus) 9, such as a mobile phone, on basis of the reason described below.

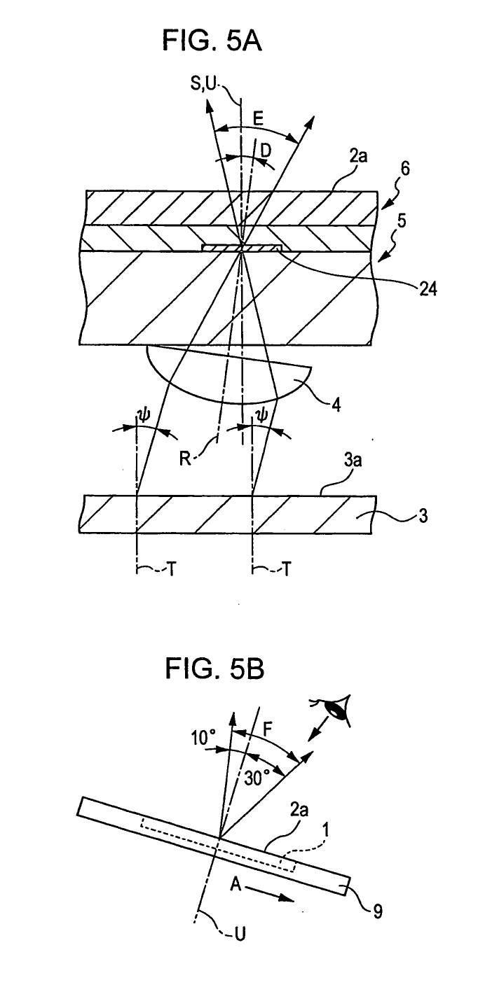

As shown in FIG. 5B, when the user uses the mobile apparatus 9 including the display element 1 according to this embodiment as a display unit while holding the mobile apparatus 9 in hand, it is known from experience that the user will be viewing the display unit (display element) of the mobile apparatus 9 at an angle mainly below the normal line U of the surface of the display unit (display element), or, more specifically, within a range (viewing angle F) of about −10° to about 30°.

For the display element 1 according to the display element 1, the range of the emission angle E of light with respect to the normal line U of each transparent electrode 24 or the display surface 2a of the liquid crystal display panel 2 is matched with the range of the above-mentioned viewing angle F of the user, for example, a range of about 10° to about 30° (i.e., within a magnitude of 40°). In this way, when the display element 1 is used as the display unit of the mobile apparatus 9, the viewing angle F of the user and the angle of the light emitted from the display surface 2a match. Thus, the user can view the display unit (display element) of the mobile apparatus 9 at an angle that achieves the highest brightness.

In FIG. 4A, the liquid crystal display panel 2 is illustrated with a predetermined thickness and predetermined distance between the transparent electrode 24 and the display surface 2a to simplify the description. The actual liquid crystal display panel used for the display element has very thin with a thickness of about 1 to about 2.2 mm. Therefore, according to FIG. 4A, the angle of the light focused at the microlens array 4 with respect to the normal line S of the transparent electrode 24 is defined as the above-described angle E. Tor the display element 1 according to this embodiment, even if the angle of the light with respect to the normal line U of the display surface 2a is set to the angle E, the angle E will be substantially equal to the angle of the light with respect to the normal line S because the change in the viewing angle of the user is negligible. Therefore, the above-described angle E may be set with respect to either the transparent electrode 24 or the display surface 2a.

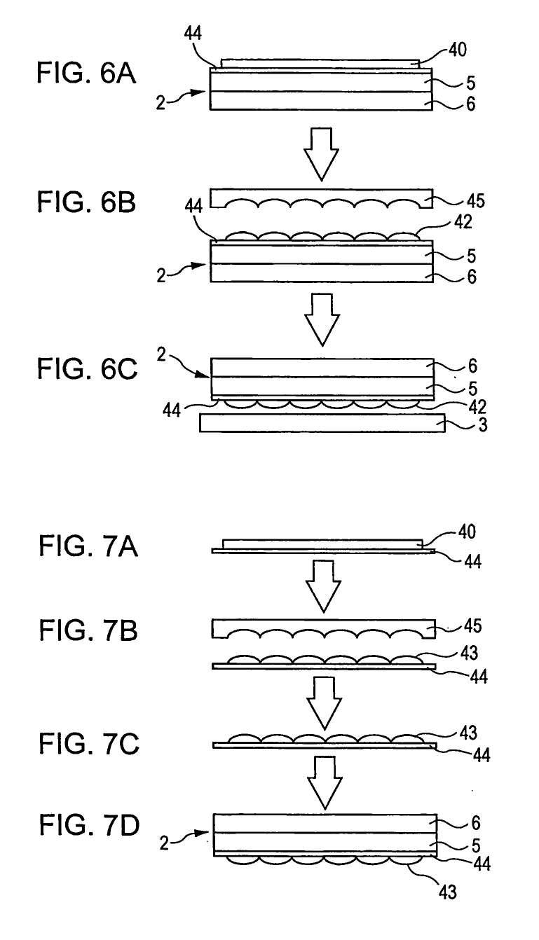

A method of disposing a microlens array, used for the display element 1 according to this embodiment, onto the surface of a lower polarizing plate provided on the back side of the liquid crystal display panel 2 (i.e., the backlight 3 side) will be described with reference to FIGS. 6 and 7.

When a microlens film is to be directly provide onto the polarizing plate 44 that is bonded to the liquid crystal display panel 2, first, a lens resin material 40 is applied to the polarizing plate 44, as shown in FIG. 6A, and prebaking is carried out. As shown in FIG. 6B, the lens resin material 40 is aligned with the pixel electrodes 52 of the liquid crystal display panel 2 (refer to FIG. 1A) and molded into the shape of lenses using a transfer mold 45. Then, mask exposure and baking are carried out. As a result, a microlens array 42 is produced. As shown in FIG. 6C, the microlens array 42 is installed in a module on the side of the backlight 3.

When the polarizing plate 44 is bonded to the liquid crystal display panel 2 after the microlens film is provided on the polarizing plate 44, the lens resin material 40 is applied to the polarizing plate 44, as shown in FIG. 7A, and then, prebaking is carried out. As shown in FIG. 7B, the lens resin material 40 is molded into the shape of lenses by using a transfer mold 45. Mask exposure and baking are carried out. After cutting the polarizing plate 44 having the microlens array 42 formed on the surface into a predetermined size, the pixel electrodes 52 (refer to FIGS. 1A and 3A) are aligned and bonded with the liquid crystal display panel 2, as shown in FIGS. 7B and 7D.

As the lens resin material, it is desirable to use a material whose photosensitivity and refraction index changes, such as polysilane resin.

It is desirable to set the baking temperature according to the process described above to the degradation temperature of the polarizing plate 44 or lower.

When producing the microlens array, a method of producing a microlens film by applying a transparent resin by inkjet application onto the positions where lenses are formed on the polarizing plate may be employed.

When a microlens array is to be interposed between the liquid crystal display panel 2 and the backlight 3, as shown in FIG. 2B, a lens resin material is applied to a transparent heat-resistant panel (not shown) consisting of resin, the lens resin material is molded into the shape of lenses, and mask exposure and baking are carried out. Then, the lenses and the pixel electrodes 52 (refer to FIGS. 1A and 3A) are aligned between the liquid crystal display panel 2 (polarizing plate 44) and the backlight 3. Then, the heat-resistant panel including the microlens array is fixed with a chassis or case. In such a method of producing a microlens array, the method described with reference to FIG. 7 may be employed. However, the method of interposing the microlens array between the liquid crystal display panel 2 and the backlight 3 is not limited to the above-described method, and other different methods may be employed.

When a microlens array is disposed on the upper surface of the backlight 3, as shown in FIG. 2C, a microlens array made from lens film or a lens plate is disposed on the prism sheet 33 (refer to FIG. 8) provided on the upper surface side of the backlight 3. Then, the microlens array may be aligned together with the backlight 3 with the pixel electrodes 52 (refer to FIG. 1A) of the liquid crystal display panel 2 and installed in a module.

As described above, for the display element 1 according to this embodiment, the microlens array 4 is interposed between the liquid crystal display panel 2 and the backlight 3 in a manner such that the positions of the microlenses and the positions of the pixel electrodes 52 of the liquid crystal display panel 2 correspond to each other. The lens axis R of each microlens is disposed at a position displaced parallel to the normal line S of the center of the transparent electrode 24 by an offset length L. Light emitted from the backlight 3 is focused at the microlens, wherein the center of the transparent electrode 24 provided in each pixel of the liquid crystal display panel 2 is set as a focal point.

Light emitted from the backlight 3 and focused at the microlenses will have directionality and can be transmitted through the liquid crystal display panel 2 at a predetermined angle with respect to the normal line to the transparent electrodes 24 or the display surface 2a of the liquid crystal display panel 2.

Consequently, the transmission efficiency of the light emitted from the backlight 3 is improved; brightness and display quality are improved; and electric power consumption is reduced. When the display element 1 according to this embodiment is installed in a mobile apparatus, the visibility of the display surface viewed by the user is significantly improved.

### SECOND EMBODIMENT

A display element according to a second embodiment will be described below with reference to the drawings.

In the description below, the components that are the same as those included in the display element 1 according to the first embodiment will be represented by reference numerals that are the same as those representing the components in the display element 1 according to the first embodiment.

As shown in FIG. 5A, a display element 11 according to this embodiment includes a microlens array 41 having microlenses. The lens axis R of each microlens of the microlens array 41 is tilted by an offset angle D with respect to a normal line S of the center of each transparent electrode 24.

As shown in FIG. 5A, even when light emitted from the backlight 3 is not parallel to the liquid crystal display panel 2 (i.e., not disposed at 0°) and, instead, is emitted at an angle of, for example, 10°, light can be efficiently focused at the center of each transparent electrode 24 by the refraction effect and focusing effect of the microlens array 41 disposed at an angle.

By setting the offset angle D of the lens axis R of each microlens of the microlens array 41 appropriately with respect to the normal line S, the emission angle of light emitted from a display surface 2a of a liquid crystal display panel 2 with respect to the normal line U of the display surface 2a can be set. In this way, the brightness and the visibility of the display element 11 and the display units of the mobile apparatus 9 including the display element 11 can be improved.

### EXAMPLES

Examples of the display element 11 will be described below.

The liquid crystal display panel 2, such as that shown in FIG. 1A, was produced by providing a microlens array having a thickness of 0.1 mm as focusing means while aligning the microlens array with pixel electrodes and using an adhesive to bond this microlens array to the back side of a TFT substrate body of a semi-transmissive TFT liquid crystal display. A display element was produced by disposing a prism sheet on the supper surface (i.e., liquid crystal display panel side) of a light-guiding plate of a backlight, as that shown in FIG. 8.

Similar to the example shown in FIG. 8, a beam of light emitted from the backlight was tilted in a direction opposite to the position of the light source. Moreover, the inclination angles θ₁ and θ₂ of the prism sheet were set, so that the average emission angle ψ was 30° with respect to the normal line T.

A semi-transmissive TFT liquid crystal display element having a 30% aperture ratio of the transparent electrodes to the pixel electrodes, a pixel size of 180 μm×60 μm, and a transparent electrode size of 36μ×40 μm was used.

As shown in FIG. 8, for the backlight, a prism sheet was disposed on the front surface of a light-guiding plate. The emission angle α of the light emitted from the surface of the light-guiding plate of the backlight with respect to the normal line was 75°, and the refraction index n of the prism sheet was 1.49. The inclination angles of each prism of the prism sheet illustrated in FIG. 8B was determined, from Expression 1, as θ₁=50° and θ₂=56.8°, and, consequently, the diffusion angle with respect to the light-emitting surface of the backlight was set to 0°.

Each microlens of the microlens array was disposed at an offset position in a manner such that the lens axis was displaced from the normal line to the center of each transparent electrode by 550×tan ψμm in the upper direction of the display surface of the display element (i.e., left in FIG. 4A and left in FIG. 8A illustrating the backlight).

The inclination direction of light focused at and transmitted through the transparent electrodes of the liquid crystal display panel by the microlens array was set to a direction opposite to the position of the light source (i.e., right in FIGS. 8A and 8B and FIG. 4A), in a similar manner as setting the emission direction of light emitted from the above-described backlight.

A known display element (comparative example) was produced in the same way as described above, except that each microlens of the microlens array was disposed, without offset, on the back side of the TFT substrate body of the semi-transmissive TFT liquid crystal display element by matching the lens axis and the normal line to the center of each transparent electrode and that a prism sheet was not disposed on the light-guiding plate of the backlight.

By using the above-described example and the comparative example, the transmission (%) at each angle with respect to the normal line to the front surface of the display element was measured.

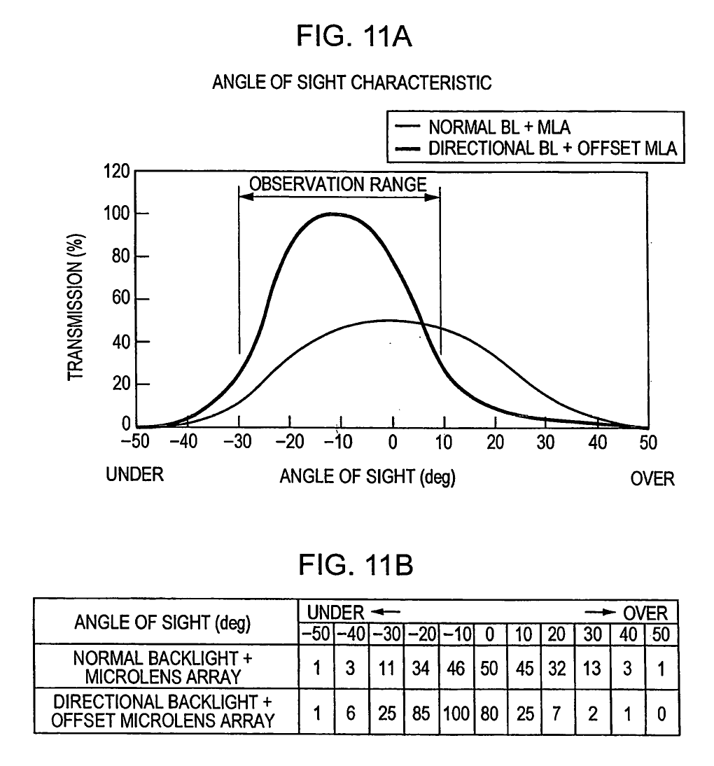

FIG. 11 illustrates the relationship between the viewing angle (i.e., viewing angle F of user) with respect to the normal line to the front surface of the display element (i.e., viewing angle 0°) and the transmission of the liquid crystal display panel for light emitted from the backlight.

As shown in the graph in FIG. 11A and the data table in FIG. 11B, according to the display element according to this example, the transmission reached a peak at substantially 100% when the viewing angle was about 10° downward with respect to the normal line to the front surface of the display element (i.e., viewing angle 0°). High transmission that enables viewing was observed within a range of about 10° upward to about 30° downward.

In contrast, for the viewing angle of a known display element, as shown in the graph in FIG. 11A, the transmission was represented as a bell curve with a peak at substantially 50%, and transmission that enables viewing was observed within a rough range of about −20° to about 20° with respect to the normal line.

The above-described data clearly shows that the display apparatus is capable of emitting light from the front surface of the display element at an angle matching the viewing angle of the user viewing the display element in a mobile apparatus. This is because the display apparatus according to the embodiments is capable of collimating light emitted from the light-guiding plate of the backlight with a prism sheet, and the collimated light is focused at the center of each transparent electrode and transmitted through the liquid crystal display panel using a microlens array disposed at an offset position, as described above.

It is demonstrated that the display element according to the embodiments of the present invention allows a user to view the display element at highest brightness and visibility.

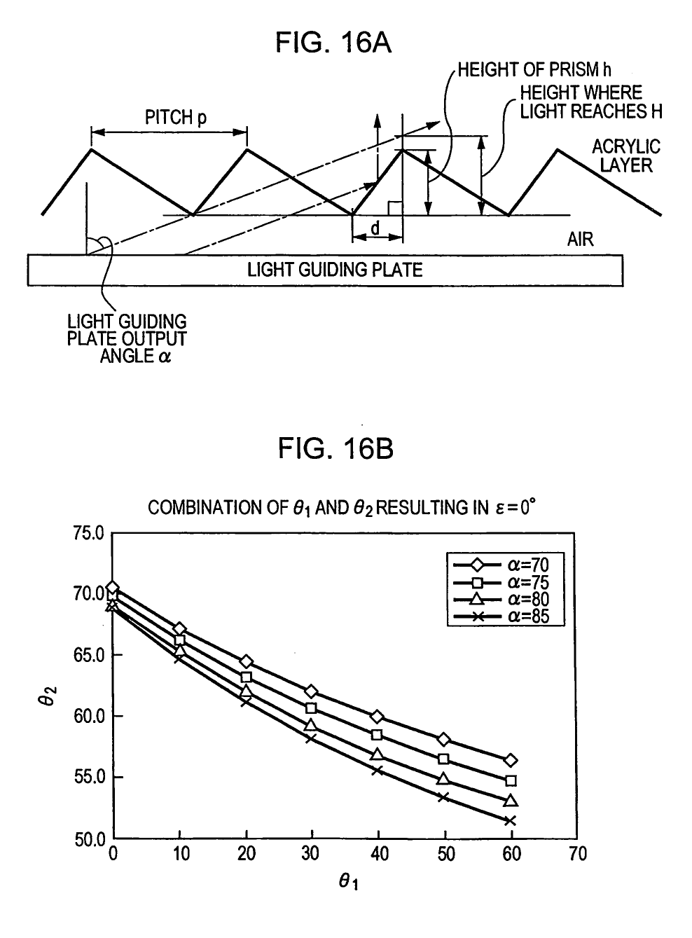

FIGS. 12 to 15 show data obtained by measuring the relationship between the inclination angles θ₁ and θ₂ of a prism sheet and the light-emitting angle of a backlight. FIG. 16B shows a graph obtained by plotting the data in FIGS. 12 to 15.

If the relationship of a height H where light reaches and a prism height h, as shown in FIG. 16A, is H<h, the use efficiency of the light is increased. Thus, it is desirable to set the angles θ₁ and θ₂ within a range that satisfies H<h.

The relationship between the angles and the size, shown in FIGS. 8B and 16A, is represented by the following expressions:
d=p×tan θ₁/(tan θ₁+tan θ₂)
H≈(p+d)/tan α
h=d×tan θ₂

As shown in FIGS. 12 to 15 and FIG. 16B, it is desirable to set the inclination angle θ₁ as θ₁>30° when α=70°, θ₁>20° when α=75°, θ₁>10° when α=80°, and θ₁>0° when α=85°. The range of the inclination angle θ₂ is uniquely determined on the basis of α and θ₁. By setting the inclination angle θ₁ when the angle α is set at the above-described angle within the above-described range and uniquely determining the inclination angle θ₂, the relationship between the height H where light reaches and the prism height h satisfies H<h. Thus, the use efficiency of the emitted light can be increased. Moreover, the angle of the light emitted from the backlight can be minimized such that the angle is within in the range of about −20° to about 20°, or more desirably about −10° to about 10°.

When H>h, part of the light incident on the prism sheet is not incident on the surface on the θ₂ side. Thus, the use efficiency of light is reduced. Therefore, it is desirable to satisfy the condition H<h.

### First Example Product

A display element was produced by disposing a microlens array at an offset position and disposing a prism sheet on a light-guiding plate of a backlight according to a similar process as that of the above-described example, except that a transmissive TFT liquid crystal display element was used as a liquid crystal display element.

By carrying out measurements in the same manner as that in the above-described example, a light transmitting characteristic similar to the above-described example was obtained.

### Second Example Product

A display element was produced by disposing a microlens array at an offset position and disposing a prism sheet on a light-guiding plate of a backlight according to a similar process as that of the above-described example, except that a semi-transmissive super twisted nematic (STN) liquid crystal display element was used as a liquid crystal display element.

By carrying out measurements in the same manner as that in the above-described example, a light transmitting characteristic similar to the above-described example was obtained.

### Third Example Product

A display element was produced by disposing a microlens array at an offset position according to a similar process as that of the above-described example, except that the microlens array was bonded onto the backlight of the semi-transmissive TFT liquid crystal display element and the liquid crystal display unit and the backlight were aligned and fixed with a chassis.

By carrying out measurements in the same manner as that in the above-described example, a light transmitting characteristic similar to the above-described example was obtained.

### Fourth Example Product

A display element was produced by disposing a microlens array at an offset position according to a similar process as that of the above-described example, except that a prism mirror was disposed on the back side of the light-guiding plate of the backlight.

By carrying out measurements in the same manner as that in the above-described example, a light transmitting characteristic similar to the above-described example was obtained.

### Fifth Example Product

A display element was produced by disposing focusing means at offset positions according to a similar process as that of the above-described example, except that a lenticular lens or gradient index glass was used as the focusing means.

By carrying out measurements in the same manner as that in the above-described example, the same focusing effect as that of the above-described example, as shown in FIG. 11, was obtained for each example product.

### Sixth Example Product

A display element was produced through a process including the steps of: applying polysilane resin at a thickness of 20 μm on the backlight side substrate surface of a second substrate of a semi-transmissive TFT liquid crystal display element; carrying out mask exposure by emitting an ultraviolet beam at 6 J/cm² while aligning the substrate with the liquid crystal layer surface mark; forming minute concave and convex lenses at offset positions with respect to the transparent electrodes; then, baking the substrate at 200° C.; cutting the substrate; and injecting liquid crystal to the substrate.

A display element according to an embodiment of the present invention was produced by using a semi-transmissive STN liquid crystal display element or a transmissive TFT liquid crystal display element as a liquid crystal display element.

By carrying out measurements in the same manner as that in the above-described example, the same focusing effect as that of the above-described example, as shown in FIG. 11, was obtained for each example product.

### Seventh Example Product

A display element was produced through a process including the steps of: applying polysilane resin at a thickness of 20 μm on the backlight side substrate surface of a second substrate of a semi-transmissive TFT liquid crystal display element; carrying out gray scale mask exposure by emitting an ultraviolet beam at 6 J/cm² while aligning the substrate with the liquid crystal layer surface mark; forming minute concave and convex lenses at offset positions with respect to the transparent electrodes; then, baking the substrate at 200° C.; cutting the substrate; and injecting liquid crystal to the substrate.

A display element was produced by using a semi-transmissive STN liquid crystal display element or a transmissive TFT liquid crystal display element as a liquid crystal display element.

By carrying out measurements in the same manner as that in the above-described example, the same focusing effect as that of the above-described example, as shown in FIG. 11, was obtained for each example product.

### Eighth Example Product

A display element was produced through a process including the steps of: applying transparent resin by an inkjet application on the backlight side substrate surface of a second substrate of a semi-transmissive TFT liquid crystal display element while aligning the substrate with the liquid crystal layer surface mark; forming minute concave and convex lenses at offset positions with respect to the transparent electrodes; then, baking the substrate at 200° C.; cutting the substrate; and injecting liquid crystal to the substrate.

A display element was produced by using a semi-transmissive STN liquid crystal display element or a transmissive TFT liquid crystal display element as a liquid crystal display element.

By carrying out measurements in the same manner as that in the above-described example, the same focusing effect as that of the above-described example, as shown in FIG. 11, was obtained for each example product.

What is claimed is:

1. A display element comprising:
a liquid crystal display panel having liquid crystal sealed between first and second substrates, the first and second substrates being disposed opposite to each other; and
a backlight that illuminates the liquid crystal display panel, wherein,
electrodes and an alignment film are provided on the liquid crystal layer side of the first substrate and the liquid crystal layer side of the second substrate,
some of the electrodes on the second substrate are light-reflecting pixel electrodes,
a light-transiting portion is formed on part of each of the pixel electrodes,
light-transmitting display unit are formed by providing transparent electrodes in the areas where the light-transiting portions are formed,
areas where light-reflecting pixel electrodes are provided function as light-reflecting display units,
the backlight is disposed on the second substrate side, and
light emitted from the backlight and transmitted through the liquid crystal display panel is emitted from the liquid crystal display panel at a predetermined angle with directionality with respect to the normal line to the light-reflecting display unit or with respect to the display surface of the liquid crystal display panel.

2. The display element according to claim 1, wherein the directionality is oriented toward the viewing direction of the display element.

3. The display element according to claim 1, wherein the light emitted from the backlight is transmitted through the liquid crystal display panel at an angle within a range of about −10° to about 30° with respect to the normal line to each of the light-reflecting display units or with respect to the display surface of the liquid crystal display panel.

4. The display element according to claim 1, wherein,
focusing means are interposed between the liquid crystal display panel and the backlight in a manner such that the positions of the focusing means corresponds to positions of the pixel electrodes,
the focal axis of each of the focusing means is disposed at an offset position parallel to the normal line to the center of each of the light-transmitting display units, and
the light emitted from the backlight is focused by each of the focusing means and is focused at a focal point at the center of each of the light-transmitting display units.

5. The display element according to claim 1, wherein,
focusing means are interposed between the liquid crystal display panel and the backlight in a manner such that the positions of the focusing means correspond to the positions of the pixel electrodes,
the focal axis of each of the focusing means is disposed at an inclined position with an offset angle with respect to the normal line to the center of each of the light-transmitting display units, and
the light emitted from the backlight is focused by each of the focusing means and is focused at a focal point at the center of each of the light-transmitting display units.

6. The display element according to claim 1, wherein the percentage of the area of the light-transmitting display unit to the area of the pixel electrode is within a range of about 5% to about 90%.

7. The display element according to claim 1, wherein the percentage of the area of the light-transmitting display unit to the area of the pixel electrodes is within a range of about 10% to about 80%.

8. The display element according to claim 1, wherein light emitted from the backlight is emitted at an angle within a range of about −20° to about 20° with respect to the normal line of the emission surface of the backlight.

9. The display element according to claim 1, wherein light emitted from the backlight is emitted at an angle within a range of about −10° to about 10° with respect to the normal line of the emission surface of the backlight.

10. The display element according to claim 4, wherein the focusing means are provided on the lower surface of the second substrate of the liquid crystal display panel.

11. The display element according to claim 4, wherein the focusing means is one of a microlens array, a lenticular lens, Fresnel lens, and gradient index lens.

12. An electronic apparatus comprising:
a display element according to claim 1.

13. A method of producing a display element, the display element including a liquid crystal display panel having liquid crystal sealed between first and second substrates, the first and second substrates being disposed opposite to each other and a backlight that illuminate the liquid crystal display panel, wherein electrodes and an alignment film are provided on the liquid crystal layer side of the first substrate and the liquid crystal layer side of the second substrate, respectively, wherein some of the electrodes on the second substrate are light-reflecting pixel electrodes, wherein a light-transiting portion is formed on part of each of the pixel electrodes, wherein light-transmitting display unit are formed by providing transparent electrodes in the areas where the light-transiting portions are formed, wherein areas where light-reflecting pixel electrodes are provided function as light-reflecting display units, wherein the backlight is disposed on the second substrate side, wherein a microlens array is interposed between the liquid crystal display panel and the backlight in a manner such that the positions of microlenses of the microlens array correspond to positions of the pixel electrodes, wherein the focal axis of each of the microlenses is disposed at an offset position parallel to the normal line to the center of each of the light-transmitting display units or at an inclined position with an offset angle, and wherein the light emitted from the backlight is focused by each of the microlenses and is focused at a focal point at the center of each of the light-transmitting display units, the method comprising the step of:
producing the microlens array by carrying out mask exposure to a material whose photosensitivity and refraction index change after applying the material to the backlight side surface of the second substrate.

14. A method of producing a display element, the display element including a liquid crystal display panel having liquid crystal sealed between first and second substrates, the first and second substrates being disposed opposite to each other and a backlight that illuminate the liquid crystal display panel, wherein electrodes and an alignment film are provided on the liquid crystal layer side of the first substrate and the liquid crystal layer side of the second substrate, respectively, wherein some of the electrodes on the second substrate are light-reflecting pixel electrodes, wherein a light-transiting portion is formed on part of each of the pixel electrodes, wherein light-transmitting display unit are formed by providing transparent electrodes in the areas where the light-transiting portions are formed, wherein areas where light-reflecting pixel electrodes are provided function as light-reflecting display units, wherein the backlight is disposed on the second substrate side, wherein a microlens array is interposed between the liquid crystal display panel and the backlight in a manner such that the positions of microlenses of the microlens array correspond to positions of the pixel electrodes, wherein the focal axis of each of the microlenses is disposed at an offset position parallel to the normal line to the center of each of the light-transmitting display units or at an inclined position with an offset angle, and wherein the light emitted from the backlight is focused by each of the microlenses and is focused at a focal point at the center of each of the light-transmitting display units, the method comprising the step of:
producing the microlens array by applying transparent resin to the backlight side surface of the second substrate by inkjet application.

15. A method of producing a display element comprising:
producing a microlens array by carrying out a mask exposure to a material whose photosensitivity and refraction index change after applying the material to the backlight side surface of the second substrate.

16. The method according to claim 15, wherein the display element includes:
a liquid crystal display panel having liquid crystal sealed between first and second substrates, the first and second substrates being disposed opposite to each other and a backlight for illuminating the liquid crystal display panel, wherein electrodes and an alignment film are provided on the liquid crystal layer side of the first substrate and the liquid crystal layer side of the second substrate,
wherein some of the electrodes on the second substrate are light-reflecting pixel electrodes,
wherein a light-transiting portion is formed on part of each of the pixel electrodes,
wherein light-transmitting display unit are formed by providing transparent electrodes in the areas where the light-transiting portions are formed,
wherein areas where light-reflecting pixel electrodes are provided function as light-reflecting display units,
wherein the backlight is disposed on the second substrate side,
wherein a microlens array is interposed between the liquid crystal display panel and the backlight in a manner such that the positions of microlenses of the microlens array correspond to positions of the pixel electrodes,
wherein the focal axis of each of the microlenses is disposed at an offset position parallel to the normal line to the center of each of the light-transmitting display units or at an inclined position with an offset angle, and
wherein the light emitted from the backlight is focused by each of the microlenses and is focused at a focal point at the center of each of the light-transmitting display units

17. A method of producing a display element comprising:
producing the microlens array by applying transparent resin to the backlight side surface of the second substrate by inkjet application.

18. The method of producing a display element according to claim 17, wherein the display element includes:
a liquid crystal display panel having liquid crystal sealed between first and second substrates, the first and second substrates being disposed opposite to each other and a backlight that illuminates the liquid crystal display panel,
wherein electrodes and an alignment film are provided on the liquid crystal layer side of the first substrate and the liquid crystal layer side of the second substrate,
wherein some of the electrodes on the second substrate are light-reflecting pixel electrodes,
wherein a light-transiting portion is formed on part of each of the pixel electrodes, wherein light-transmitting display unit are formed by providing transparent electrodes in the areas where the light-transiting portions are formed,
wherein areas where light-reflecting pixel electrodes are provided function as light-reflecting display units,
wherein the backlight is disposed on the second substrate side,
wherein a microlens array is interposed between the liquid crystal display panel and the backlight in a manner such that the positions of microlenses of the microlens array correspond to positions of the pixel electrodes,
wherein the focal axis of each of the microlenses is disposed at an offset position parallel to the normal line to the center of each of the light-transmitting display units or at an inclined position with an offset angle, and
wherein the light emitted from the backlight is focused by each of the microlenses and is focused at a focal point at the center of each of the light-transmitting display units
